(19) United States
(12) Patent Application Publication
(10) Pub. No.: US 2016/0035207 A1
(43) Pub. Date: Feb. 4, 2016

(54) Proximity Warning Assembly

(71) Applicant: Robert M. Ledford, Marysville, CA (US)

(72) Inventor: Robert M. Ledford, Marysville, CA (US)

(21) Appl. No.: 14/449,682

(22) Filed: Aug. 1, 2014

(51) Int. Cl. G08B 21/04

(52) U.S. Cl. CPC G08B 21/0476

(57) ABSTRACT

A proximity warning assembly includes a handheld electronic device. A display is coupled to the handheld electronic device. A camera is coupled to the handheld electronic device. The camera is directed forwardly from a user while the user utilizes the handheld electronic device. The camera is operationally coupled to the display. An alarm is coupled to the handheld electronic device. A motion sensor is coupled to the handheld electronic device. The motion sensor is operationally coupled to the alarm and the camera. The motion sensor actuates the alarm and the camera when the motion sensor detects a hazard that the user is not observing. The camera displays the hazard and the alarm generates an alarm when the motion sensor detects the hazard. The user is notified of the hazard.

### BACKGROUND OF THE DISCLOSURE

### Field of the Disclosure

The disclosure relates to warning devices and more particularly pertains to a new warning device for warning a user of a hazard while the user is utilizing a handheld electronic device.

### SUMMARY OF THE DISCLOSURE

An embodiment of the disclosure meets the needs presented above by generally comprising a handheld electronic device. A display is coupled to the handheld electronic device. A camera is coupled to the handheld electronic device. The camera is directed forwardly from a user while the user utilizes the handheld electronic device. The camera is operationally coupled to the display. An alarm is coupled to the handheld electronic device. A motion sensor is coupled to the handheld electronic device. The motion sensor is operationally coupled to the alarm and the camera. The motion sensor actuates the alarm and the camera when the motion sensor detects a hazard that the user is not observing. The camera displays the hazard and the alarm generates an alarm when the motion sensor detects the hazard. The user is notified of the hazard.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a proximity warning assembly according to an embodiment of the disclosure.

FIG. 2 is a front view of an embodiment of the disclosure.

FIG. 3 is an in-use view of an embodiment of the disclosure.

FIG. 4 is a schematic view of an embodiment of the disclosure.

FIG. 5 is a top view of an embodiment of the disclosure.

### DESCRIPTION OF THE PREFERRED EMBODIMENT

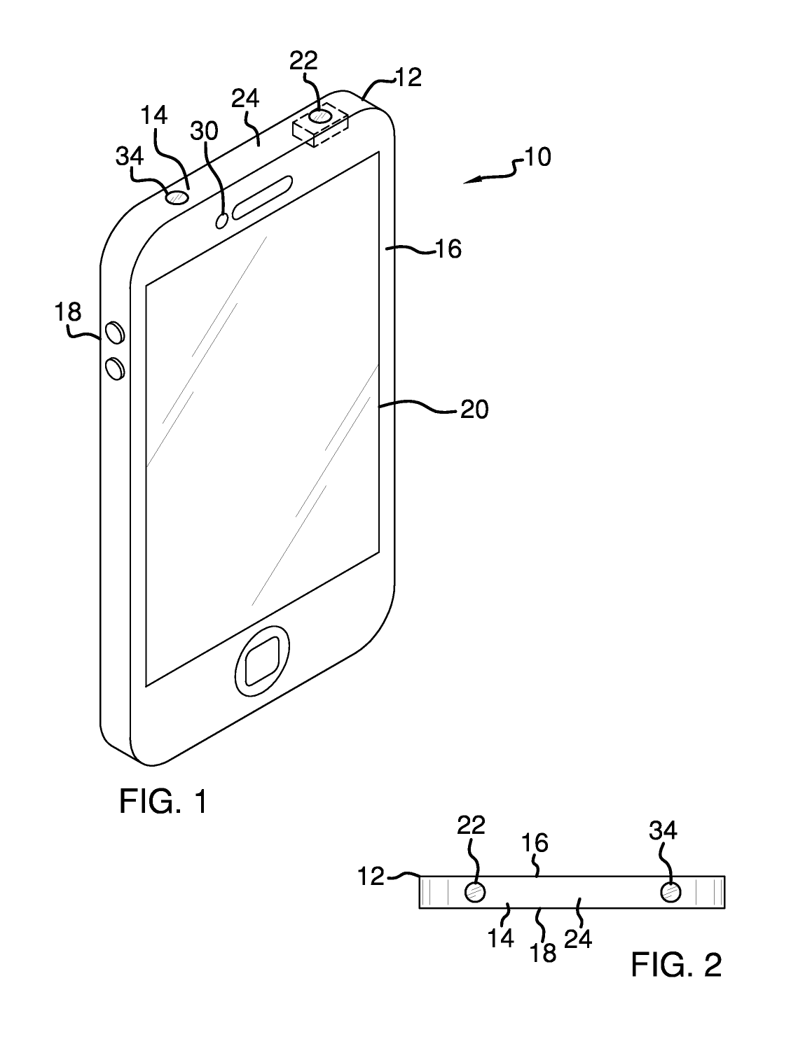

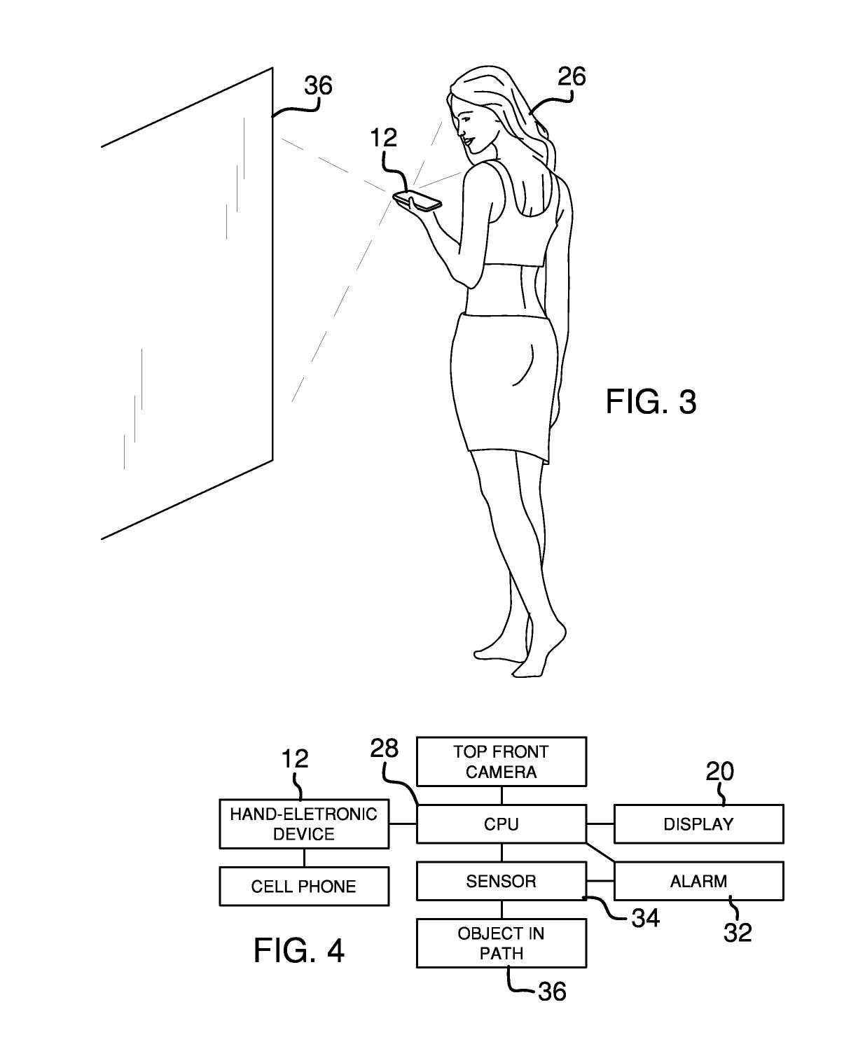

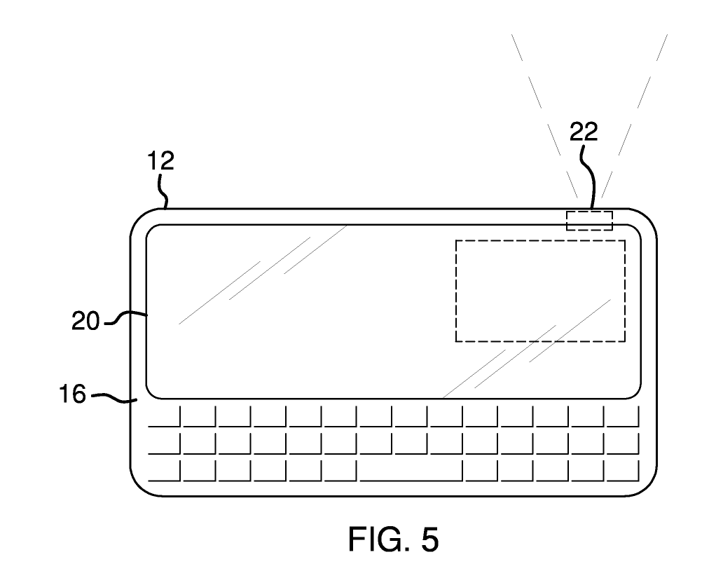

With reference now to the drawings, and in particular to FIGS. 1 through 5 thereof, a new warning device embodying the principles and concepts of an embodiment of the disclosure and generally designated by the reference numeral 10 will be described.

As best illustrated in FIGS. 1 through 5, the proximity warning assembly 10 generally comprises a handheld electronic device 12. The handheld electronic device 12 has a perimeter edge 14 extending between a top side 16 and a bottom side 18 of the handheld electronic device 12. Moreover, the handheld electronic device 12 may be a smart phone of any conventional design.

A display 20 is coupled to coupled to the top side 16 of the handheld electronic device 12. The display 20 may be a smart phone display of any conventional design. A camera 22 is coupled to coupled to a front side 24 of the perimeter edge 14 of the handheld electronic device 12. The display 20 is visible to a user 26. The camera 22 is directed forwardly from a user 26 while the user 26 observes the display 20.

The camera 22 is electrically coupled to the display 20. The camera 22 and the display 20 are each additionally electrically coupled to a processor 28 in the handheld electronic device 12. The processor 28 may be a smart phone processor of any conventional design. Additionally, the camera 22 is utilized in conjunction with an existing smart phone camera 30 of any conventional design.

An alarm 32 is coupled to the handheld electronic device 12. The alarm 32 vibrationally engages the bottom side 18 of the handheld electronic device 12. A motion sensor 34 is coupled to the front side 24 of the perimeter edge 14 of the handheld electronic device 12. The motion sensor 34 is directed forwardly from the user 26 while the user 26 observes the display 20. Additionally, the motion sensor 34 may be an electronic motion sensor of any conventional design.

The motion sensor 34 is electrically coupled to the alarm 32 and the camera 22. The motion sensor 34 actuates the alarm 32 and the camera 22 when the motion sensor 34 detects a hazard 36 that the user 26 is not observing. The hazard 36 may be an object located in front of the user 26.

The camera 22 displays the hazard 36 on the display 20 in a picture in picture configuration when the motion sensor 34 detects the hazard 36. The user 26 is visually notified of the hazard 36 while the user 26 is observing the display 20. Additionally, the alarm 32 generates an alarm when the motion sensor 34 detects the hazard 36. The user 26 receives a haptic notification of the hazard 36 while the user 26 is observing the display 20.

In use, the motion sensor 34 monitors activity in front of the user 26 when the user 26 is viewing the display 20 on the handheld electronic device 12. The handheld electronic device 12 is oriented so the front side 24 of the perimeter edge 14 is directed forwardly from the user 26 while the user 26 observes the display 20. The motion sensor 34 allows the user 26 to be notified of the hazard 36 of which the observer 26 might otherwise remain unaware while utilizing the handheld electronic device 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A proximity warning assembly comprising:
a handheld electronic device;
a display coupled to said handheld electronic device;
a camera coupled to said handheld electronic device such that said camera is directed forwardly from a user while the user utilizes said handheld electronic device, said camera being operationally coupled to said display;
an alarm coupled to said handheld electronic device; and
a motion sensor coupled to said handheld electronic device, said motion sensor being operationally coupled to said alarm and said camera, said motion sensor actuating said alarm and said camera when said motion sensor detects a hazard that the user is not observing, said camera displaying the hazard and said alarm generating an alarm when said motion sensor detects the hazard such that the user is notified of the hazard.

2. The proximity warning assembly according to claim 1, further comprising said handheld electronic device having a perimeter edge extending between a top side and a bottom side of said handheld electronic device, said display being coupled to said top side of said handheld electronic device such that said display is visible to the user.

3. The proximity warning assembly according to claim 2, further comprising said camera being coupled to a front side of said perimeter edge of said handheld electronic device such that said camera is directed forwardly from the user while the user observes said display.

4. The proximity warning assembly according to claim 3, further comprising said camera being electrically coupled to said display.

5. The proximity warning assembly according to claim 2, further comprising said motion sensor being coupled to a front side of said perimeter edge of said handheld electronic device such that said motion sensor is directed forwardly from the user while the user observes said display.

6. The proximity warning assembly according to claim 5, further comprising said motion sensor being electrically coupled to said alarm and said camera.

7. The proximity warning assembly according to claim 6, further comprising said camera displaying the hazard on said display when said motion sensor detects the hazard such that the user is visually notified of the hazard while the user is observing said display.

8. The proximity warning assembly according to claim 6, further comprising said alarm generating the alarm when said motion sensor detects the hazard such that the user receives a haptic notification of the hazard while the user is observing said display.

9. A proximity warning assembly comprising:
a handheld electronic device having a perimeter edge extending between a top side and a bottom side of said handheld electronic device;
a display coupled to coupled to said top side of said handheld electronic device such that said display is visible to a user;
a camera coupled to coupled to a front side of said perimeter edge of said handheld electronic device such that said camera is directed forwardly from the user while the user observes said display, said camera being electrically coupled to said display;
an alarm coupled to said handheld electronic device;
a motion sensor coupled to said front side of said perimeter edge of said handheld electronic device such that said motion sensor is directed forwardly from the user while the user observes said display, said motion sensor being electrically coupled to said alarm and said camera, said motion sensor actuating said alarm and said camera when said motion sensor detects a hazard that the user is not observing;
said camera displaying the hazard on said display when said motion sensor detects the hazard such that the user is visually notified of the hazard while the user is observing said display; and
said alarm generating an alarm when said motion sensor detects the hazard such that the user receives a haptic notification of the hazard while the user is observing said display.
